(19) United States
(12) Patent Application Publication
(10) Pub. No.: US 2024/0100642 A1
(43) Pub. Date: Mar. 28, 2024

(54) METHOD FOR PROTECTING A USER DURING OPERATION OF A POWER TOOL, AND POWER TOOL

(71) Applicant: Hilti Aktiengesellschaft, Schaan (LI)

(72) Inventors: Ralf GREITMANN, Kaufering (DE); Jens IMASCHEWSKI, Puchheim (DE)

(21) Appl. No.: 18/038,481

(22) PCT Filed: Nov. 11, 2021
(86) PCT No.: PCT/EP2021/081389

§ 371 Date: May 24, 2023

(30) Foreign Application Priority Data
Dec. 4, 2020 (EP) 20211907.9

(51) Int. Cl. B23Q 17/12; B24B 23/00; B24B 41/00

(52) U.S. Cl. CPC B23Q 17/12; B24B 23/005; B24B 41/007

(57) ABSTRACT

A method for protecting a user of a power tool from the effects of a suddenly occurring imbalance, and to a power tool having a disk-shaped tool for carrying out the method. The power tool has at least one acceleration sensor which is configured to detect vibrations which occur during the operation of the power tool. The vibration values determined can be evaluated and compared with specified limit values, wherein the power tool can be switched off if the vibration values exceed a corresponding limit value. By switching off the power tool, which can be achieved in various ways, the power tool affords optimum user protection against the effects of a suddenly occurring imbalance that may occur, for example, in the event of a defective tool of the power tool.

The present invention relates to a method for protecting a user of a power tool from the effects of a suddenly occurring imbalance, and to a power tool having a disk-shaped tool, wherein the method can be carried out with the power tool.

### BACKGROUND

In the power tool sector, cut-off grinders or angle grinders by means of which cuts can be made in a substrate to be machined or which can be used to machine the surface of a substrate are known. Such cut-off or angle grinders generally have a disk-shaped tool, which is referred to as a cutting or grinding disk. The circumference of such a cutting or grinding disk can have preferably symmetrically arranged and configured segments, wherein the segments are separated from one another by radially running slots. Due to their configuration, these segments may break out of the cutting disk, in particular during operation of a cut-off grinder.

### SUMMARY OF THE INVENTION

The cutting disk thereby loses its symmetry, and undesirable imbalance phenomena may occur which may make the operation of the cut-off grinder difficult or impossible. The sudden occurrence of an imbalance can also constitute a risk for the user since powerful vibrations may occur due to the imbalance. This may lead to the user losing control of the device.

An object on which the present invention is based consists in overcoming the above-described defects and disadvantages of the prior art and in providing a method for protecting a user of a power tool, with which in particular the negative effects of a suddenly occurring imbalance are mitigated or avoided. In particular, an operating risk for the user of the power tool is intended to be reduced and the operation of the power tool made safer. Another concern of the invention is to provide a power tool having a disk-shaped tool with which the user can work particularly safely and during the operation of which the user is optimally protected from the effects of a suddenly occurring imbalance and the powerful vibrations which may be associated therewith.

According to the invention, a method for protecting a user of a power tool from the effects of a suddenly occurring imbalance is provided. The method is characterized by the following method steps:
a) providing a power tool having a disk-shaped tool, wherein the power tool comprises at least one acceleration sensor,
b) operating the power tool,
c) detecting, with the at least one acceleration sensor, vibrations which occur during the operation of the power tool,
d) evaluating the vibrations detected in method step c), wherein the evaluation comprises comparing the vibration values with a specified limit value for the vibrations,
e) protecting the user by switching off the power tool if the vibration values exceed the specified limit value.

An aim which is achieved with the method for user protection is to switch off the power tool as rapidly as possible or to separate the tool from the drive of the power tool if an imbalance of the tool exceeds a certain rate defined previously as hazardous. This rate previously classified as hazardous is expressed by the specified limit value, upon the exceeding of which the power tool is switched off according to the proposed method.

In a second aspect, the invention relates to a power tool having a disk-shaped tool. The terms, definitions and technical advantages introduced for the user protection method apply in an analogous manner to the power tool. The power tool is characterized in that it comprises at least one acceleration sensor for detecting vibrations which occur during the operation of the power tool.

For the purposes of the invention, it is preferred that the power tool is a cut-off grinder. The cut-off grinder can comprise a rear region, which is formed by a main body and a protection frame. The main body of the cut-off grinder can be surrounded by a housing, and can comprise an energy supply unit, a control unit, a drive or a drive train and/or a motor. For the purposes of the invention, it is preferred that the power tool comprises a rechargeable battery (“battery”) as an energy source. The protection frame can comprise a front, circumferential handle and a second, upper handle. The front part of the power tool is formed by the tool thereof, which, particularly in the case where the power tool is designed as a cut-off grinder, is a disk-shaped tool. In particular, it may be referred to as a cutting disk. The circumference of the cutting disk has preferably symmetrically configured segments, wherein the segments are separated from one another by radially running slots. For the purposes of the invention, it is preferred that the spatial directions of “front” and “rear” are defined by the front power tool region formed by the tool and by the rear power tool region formed inter alia by the main body.

The power tool comprises in particular a carrier arm for the disk-shaped tool, on which the at least one acceleration sensor can be arranged. For the purposes of the invention, it is preferred that the acceleration sensor is arranged on a front region of the carrier arm for the disk-shaped tool. Preferably, for the purposes of the invention, the acceleration sensor arranged preferably in the front region of the carrier arm may be referred to as the “first acceleration sensor”. The front region of the carrier arm can be in particular in the spatial vicinity of a pivot point or center of rotation of the cutting disk. For the purposes of the invention, this preferably means that the acceleration sensor can be present on a tip of the carrier arm. Tests have shown that, at this position, the vibrations which are detected and evaluated within the context of the invention can be determined particularly accurately and simply.

The carrier arm of the power tool may also be referred to as a cutting arm. It is illustrated without a cover in the FIGURE in order to better show the possible positions of the acceleration sensors.

For the purposes of the invention, it is preferred that the acceleration sensor is arranged on the power tool in such a manner that it optimally detects the vibrations which occur during the operation of the power tool. In other words, the acceleration sensor is configured to detect the vibrations generated during operation of the power tool, with its arrangement within the power tool ensuring an optimum detection of the vibrations. Tests have shown that the optimum detection of the vibrations can take place in particular whenever the acceleration sensor is arranged on a front region or in the region of a tip of the cutting arm for the disk-shaped tool.

For the purposes of the invention, it is preferred to detect the vibrations permanently or continuously. The vibrations can preferably be determined in a short sequence, i.e. with very short time intervals between two measurements. The data determined with the acceleration sensor can be processed by information technology either directly in situ, for example in the sensor, and/or evaluated. For the purposes of the invention, it may also be preferred that the vibration data determined by the acceleration sensor are transmitted to a control unit of the power tool, with the data being processed and/or evaluated in the control unit. The control unit is preferably arranged in the main body of the power tool. For the purposes of the invention, it is preferred that there is a communication connection between the acceleration sensor and the control unit, which communication connection can be wireless or wired.

The evaluation of the vibration data comprises in particular comparing the vibration values detected with the acceleration sensor with a specified limit value for the vibrations. Said specified limit value for the vibrations can be stored in the power tool or outside the power tool. For example, lookup tables from which the specified limit value for the vibrations can be derived can be stored in the control unit. For the purposes of the invention, it is preferred that the limit value can vary, for example, depending on a diameter or a speed of rotation of the cutting disk. However, for the purposes of the invention, it may also be preferred that the specified vibration limit value is stored outside the power tool, i.e., for example, on a server or in a data cloud to which the power tool is connected or to which the power tool has access.

For the purposes of the invention, it is preferred that, when the vibration data are compared with the specified limit value, the data determined last, i.e. the data which are still quite fresh or current, are compared with the limit value. In the process, the current data can be averaged, for example over a short period of time, in order to prevent erroneous switching off of the power tool in the event of a measurement error or a data anomaly. However, for the purposes of the invention, it is particularly preferred that, when a change in the vibration data indicating breaking out of a segment from the cutting disk is identified, the power tool acts or reacts particularly quickly by a rapid and speedy switching off of the power tool being initiated. By speedy switching off of the power tool, particularly effective protection of the user of the power tool can be ensured when the vibration values detected with the acceleration sensor exceed the specified limit value. For the purposes of the invention, the expression “speedy switching off” preferably means that the switching off takes place, for example, in fewer than 5 seconds, preferably in fewer than 2 seconds.

Within the context of the present invention, the switching off of the power tool can be achieved in a plurality of ways. In a first variant which is particularly preferred whenever the power tool is a battery-operated cut-off grinder, the switching off of the power tool is brought about by switching off a motor of the power tool. The switching off of the power tool by the motor of the power tool being switched off ensures a particularly quick switching off of the power tool and in this way effective and speedy protection of the user. This first variant of the invention is particularly preferred because it is possible to refrain from providing an (additional) mechanical brake on the drive train or from providing a clutch for decoupling the cutting disk from the drive with the power tool. In other words, for quick braking of the preferably brushless motor, a mechanical brake or clutch for decoupling drive and cutting disk is no longer required.

The switching off of the power tool can also be achieved, for example, by a rotational speed of the cutting disk being reduced into a non-critical range. For the purposes of the invention, the expression “switching off of a motor of the power tool” which describes the first variant for switching off the power tool preferably also comprises such a reduction of the rotational speed of the disk into a non-critical range. In other words, switching off of the motor of the power tool can also be achieved by reducing the rotational speed of the disk. For the purposes of the invention, the term “non-critical” means that the rotational speed of the cutting disk is reduced to an extent such that, for example, the vibrations which may arise due to an imbalance are reduced to an acceptable extent and the user of the power tool can continue to work with the power tool safely and without adverse effects.

It is preferred, in this first variant of the method, that the motor of the power tool is a brushless motor. The braking energy can thereby be consumed in the motor of the power tool or fed back into the rechargeable batteries.

In a second variant of the invention, the switching off of the power tool can be brought about by stopping the disk-shaped tool of the power tool. Within the context of said second switching off variant, it is preferred that, for the stopping of the disk-shaped tool, a mechanical brake is provided on a drive train of the power tool. In other words, the drive train of the power tool can have an (additional) mechanical brake which is configured to quickly stop the cutting disk of the cut-off grinder when an imbalance is identified, for example due to a broken-out segment of the cutting disk. For the purposes of the invention, it is preferred in particular that an abrupt change within the vibration data of the power tool or of the control unit thereof is understood to mean that said abrupt change in the vibration data is caused by a defect-induced imbalance of the cutting disk, with said determined imbalance being reacted to by switching off the power tool. For the purposes of the invention, it is preferred that a change in the vibration data is caused by an imbalance of the tool of the power tool.

In a third variant of the invention, the switching off of the power tool can be brought about by decoupling the disk-shaped tool from a drive of the power tool, wherein, for the decoupling of the disk-shaped tool, a clutch is provided on the power tool. In this third switching off variant, the motor of the power tool continues to operate while the cutting disk is disconnected from the drive of the cut-off grinder such that torque is no longer transmitted to the cutting disk. As a result, the rotation of the cutting disk comes to a standstill and the cutting disk poses no further risk for the user. The decoupling of the tool from the drive of the power tool can be carried out in particular in addition to stopping the tool of the power tool. For the purposes of the invention, it is preferred that the switching off of the power tool with a mechanical brake can be accelerated with an additional decoupling of the disk-shaped tool. For this purpose, a clutch can be provided between the disk-shaped tool and the motor. In this switching off variant, the motor of the power tool can continue to operate while the cutting disk is disconnected from the drive of the cut-off grinder such that torque is no longer transmitted to the cutting disk. The rotation of the cutting disk can thereby come to a standstill with reduced effort and at an early point such that the cutting disk poses no further risk for the user.

Within the context of the invention, a power tool is provided which can be in particular a battery-operated cut-off grinder with special user protection. The basic concept on which the invention is based consists in particular in that the cut-off grinder can be switched off quickly if, during the cutting with the cut-off grinder, an increased imbalance occurs due to a defective cutting disk. If such an imbalance exceeds a defined value, the device can be switched off as quickly as possible in order to prevent a possible risk for the user or the device.

To realize the basic concept, it is provided, in the case of a battery-operated cut-off grinder with a preferably brushless motor, to integrate at least one acceleration sensor in such a manner that the vibrations can therefore be readily detected during the operation of the cut-off grinder. By means of this sensor or these sensors, the vibrations of the device are advantageously permanently measured. If the vibration increases above a previously defined value due to an increased imbalance at the cutting disk or at the cutting arm, the cutting disk is braked as quickly as possible and/or the drive is decoupled, in order to effectively protect the user.

For the purposes of the invention, it is preferred that the power tool has a display means in order to indicate a switching off to a user of the power tool. The display means can comprise a display and/or light-emitting diodes (LEDs). It can advantageously be indicated with such an LED display or a display to the user of the cut-off grinder that a precautionary switching off of the cut-off grinder is occurring or has occurred. The display means can be arranged in particular on an upper side of a housing of the power tool. This arrangement is particularly advantageous because the display means can thereby be seen particularly readily by the user of the power tool. The user thereby particularly quickly obtains an indication of a sudden switching off of the power tool.

For the purposes of the invention, it is preferred that the power tool comprises a second acceleration sensor for detecting vibrations which occur during the operation of the power tool. If the cut-off grinder comprises a second acceleration sensor, the vibration data detected by the two acceleration sensors can be compared with one another or set in relation to one another within the scope of the evaluation. Tests have shown that the provision of two acceleration sensors can further improve the accuracy with which an imbalance event is identified.

It is preferred within the context of the invention that criteria are defined for switching off the power tool. These criteria can relate, for example, to a change in a vibration level and/or vibration frequency over a certain period of time. It is advantageous here if two acceleration sensors are mounted on the power tool in order to be able to compare or reference the respective value of the individual sensors with one another.

For the purposes of the invention, it is preferred that the second acceleration sensor is arranged on a carrier arm for the disk-shaped tool. For the purposes of the invention, it is particularly preferred that the second acceleration sensor is arranged on a rear region of the carrier arm for the disk-shaped tool. Said rear region of the cutting arm is present in the transition between the front and the rear region of the power tool, and thus in the spatial vicinity to that region of the power tool at which the cutting arm is fastened to the main body of the power tool. By means of the detection of vibration data at different locations by the two acceleration sensors, which are preferably arranged spaced apart from each other, an even more precise identification of an imbalance can advantageously be made possible. For the purposes of the invention, it is preferred that a joint evaluation of the vibration data of the acceleration sensors takes place in the control unit. Between the second acceleration sensor and the control unit, there is therefore preferably also a communication connection which can be wireless or wired.

After the cut-off grinder has been switched off due to an identified imbalance event, the user can check the cutting disk and exchange same if required. Subsequently, the operation with the cut-off grinder can be continued as customary.

A further advantage which is associated with the invention is that the acceleration sensors can also be used for identifying a kick-back event. In the event of a kick-back, a jamming or jammed cutting disk causes an undesirable and dangerous recoil for the user. In this respect, the invention is a synergistic approach for broad user protection with which the user of the power tool can be particularly effectively protected both against imbalance events and also against kick-back events.

### BRIEF DESCRIPTION OF THE DRAWINGS

Further advantages will become apparent from the following description of the figures. The FIGURE, the description and the claims contain numerous features in combination. A person skilled in the art will expediently also consider the features individually and combine them to form useful further combinations.

In the FIGURE, the same and similar components are numbered with the same reference signs. In the FIGURE:

FIG. 1 shows a view of a preferred embodiment of the power tool.

### DETAILED DESCRIPTION

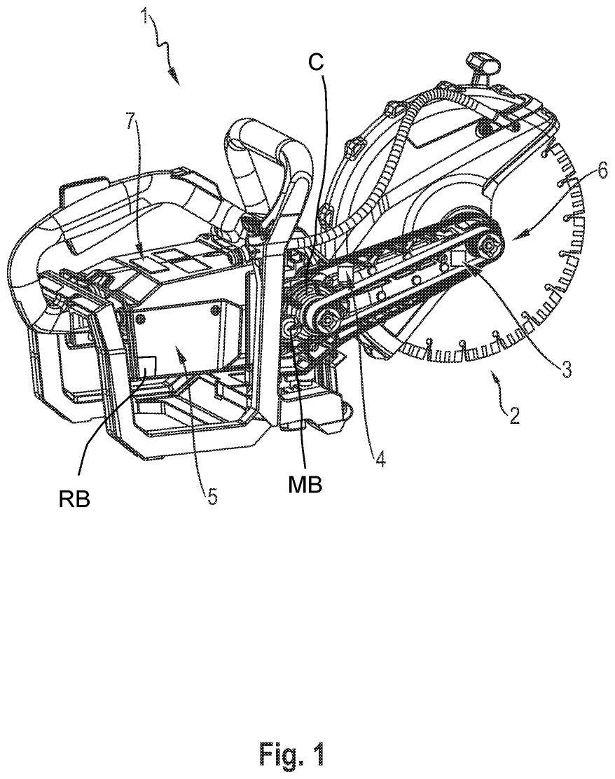

FIG. 1 shows one possible preferred embodiment of the power tool 1. In particular, a cut-off grinder 1 which has a cutting disk 2 as a disk-shaped tool 2 is illustrated. The cutting disk 2 preferably forms a front region of the power tool 1. A rear region of the power tool 1 is formed by a main body of the cut-off grinder 1, which can in particular comprise a motor 5. The main body of the power tool 1 can be surrounded, for example, by a housing and protected by a protective frame.

The disk-shaped tool 2 which is present in the front region of the cut-off grinder 1 is preferably held by a carrier arm or cutting arm 6. For the purposes of the invention, it is preferred that the cutting arm 6 extends out of the main body of the cut-off grinder 1 in the “forward” spatial direction and runs parallel to the cutting disk 2 over a large distance. In FIG. 1, the cutting arm 6 is shown without a cover in order to be able to better illustrate possible arrangements of the acceleration sensors 3, 4.

The acceleration sensors 3, 4 are preferably arranged on the cutting arm 6 of the cut-off grinder 1. For the purposes of the invention, it is preferred that a first acceleration sensor 3 is arranged in a front region of the cutting arm 6, while the second acceleration sensor 4 is arranged at a rear region of the cutting arm 6. The acceleration sensors 3, 4 are configured to detect the vibrations which arise during operation of the cut-off grinder 1 and to transmit them to a control unit of the power tool 1. The obtained vibration data are preferably evaluated in the control unit of the cut-off grinder 1, with the power tool 1 being switched off as quickly as possible when the vibration values determined exceed a specified vibration limit value. For the purposes of the invention, it is particularly preferred to evaluate those vibrations which occur in the region of the cutting arm 6 of the power tool 1 or can be detected there. The rapid switching off of the cut-off grinder 1 can be achieved, for example, by the motor 5 of the cut-off grinder 1 being turned off or by the cutting disk 2 of the cut-off grinder 1 being disconnected or decoupled from its drive or from the drive of the power tool 1. For the decoupling, the power tool 1 can have, for example, a clutch (depicted solely schematically as C). Furthermore, rotation of the cutting disk 2 can be halted or stopped if excessive vibration values are measured. For this purpose, for example, a mechanical brake (depicted solely schematically as MB) can be used. A rechargeable battery RB is also shown solely schematically.

The excessive vibration values which, according to the invention, lead to switching off of the cut-off grinder 1 may be caused in particular by a defective cutting disk 2. As can readily be seen in FIG. 1, the circumference of the cutting disk 2 has segments which are separated from one another by slots. During the operation of the cut-off grinder 1, one such segment may break out of the cutting disk 2. The breaking out of such a cutting disk segment may lead to increased vibrations and to an imbalance event, with it being possible for this to lead to a risk for the user of the cut-off grinder 1. By switching off the cut-off grinder 1 as quickly as possible when excessive vibration values and therefore a possible imbalance event are identified, this risk for the user can advantageously be considerably reduced. The excessive vibration values are characterized in particular in that they exceed a specified limit value which can be stored within the cut-off grinder 1 or outside the cut-off grinder 1.

The cut-off grinder 1 can furthermore have display means 7 with which the user is advised of a possible imbalance event or a switching off of the cut-off grinder 1. The display means 7 can comprise, for example, a display, a screen, LEDs and/or an LED display, without being restricted thereto.

### LIST OF REFERENCE SIGNS

1 Power tool
2 Disk-shaped tool
3 First acceleration sensor
4 Second acceleration sensor
5 Motor
6 Carrier arm/cutting arm
7 Display means
C Clutch
MB Mechanical Brake
RB Rechargeable Battery

What is claimed is:

1-15. (canceled)

16. A method for protecting a user of a power tool from the effects of a suddenly occurring imbalance, the method comprising:
a) providing a power tool having a disk-shaped tool and at least one acceleration sensor;
b) operating the power tool;
c) detecting, with the at least one acceleration sensor, vibrations occurring during the operation of the power tool;
d) evaluating the vibrations detected in method step c), the evaluation including comparing vibration values with a specified limit value for the vibrations; and
e) protecting the user by switching off the power tool if the vibration values exceed the specified limit value.

17. The method as recited in claim 16 wherein the switching off of the power tool is brought about by switching off a motor of the power tool.

18. The method as recited in claim 16 wherein the switching off of the power tool is brought about by stopping the disk-shaped tool of the power tool, wherein, for the stopping of the disk-shaped tool, a mechanical brake is provided on a drive train of the power tool.

19. The method as recited in claim 16 wherein the switching off of the power tool is brought about by decoupling the disk-shaped tool from a drive of the power tool, wherein, for the decoupling of the disk-shaped tool, a clutch is provided on the power tool.

20. The method as recited in claim 16 wherein the specified limit value for the vibrations is stored in the power tool or outside the power tool.

21. The method as recited in claim 16 wherein a change in the vibration data is caused by an imbalance of the disk-shaped tool of the power tool.

22. A power tool comprising:
a disk-shaped tool; and
at least one acceleration sensor for detecting vibrations occurring during operation of the power tool.

23. The power tool as recited in claim 22 wherein the acceleration sensor is arranged on the power tool so that the vibrations occurring during the operation of the power tool are optimally detected.

24. The power tool as recited in claim 22 wherein the acceleration sensor is arranged on a carrier arm for the disk-shaped tool.

25. The power tool as recited in claim 22 wherein a motor of the power tool is a brushless motor.

26. The power tool as recited in claim 22 wherein the power tool is a cut-off grinder.

27. The power tool as recited in claim 22 wherein the power tool has a rechargeable battery as an energy source.

28. The power tool as recited in claim 22 wherein the power tool has a display in order to indicate a switching off to a user of the power tool.

29. The power tool as recited in claim 22 further comprising a second acceleration sensor for detecting vibrations occurring during the operation of the power tool.

30. The power tool recited in claim 29 wherein the second acceleration sensor is arranged on a carrier arm for the disk-shaped tool.
